(19) United States
(12) Patent Application Publication
(10) Pub. No.: US 2007/0283789 A1
(43) Pub. Date: Dec. 13, 2007

(54) Multi-purpose boat tool

(76) Inventor: Gus Zeidler, St. Petersburg, FL (US)

Correspondence Address: GUS ZEIDLER, 4804 95TH. ST. N., ST. PETERSBURG, FL, 33708, US

(21) Appl. No.: 11/451,154

(22) Filed: Jun. 13, 2006

(51) Int. Cl. B25B 13/00

(52) U.S. Cl. 81/125.1

(57) ABSTRACT

The 5 Way Boat Tool presented in this Application is made out of stamped stainless Steel.

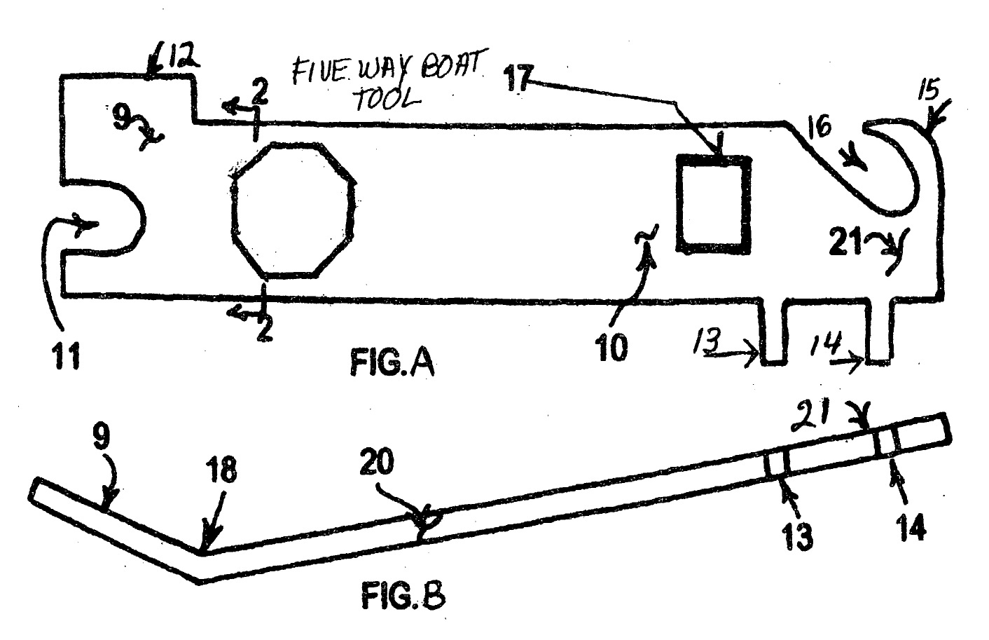

### BACKGROUND OF THE INVENTION

The field of this invention pertains to tools for boaters, campers, boat repair shops, handy men and tradesmen.

The device is a combination of five tools in one for un-snapping canvas snaps or the such, one for removing the water drain plug, one to open or close the fuel cap, one for the water cap, and one to assist in the operation of zippers.

Fuel cap openers are common to boaters as well as water cap openers and several tools are available to remove the water drain plugs.

No provisions have been made for one-piece cast or stamped steel hefty tools for performing all these functions. Though the art of producing many different types of combination tools are common, by research, it is quite evident that this area (boats) appears to be one of the lesser avenues of inventors for making or improving or improvising handy and convenient tools.

Examples of the known art are shown in the following:

| | | |
|---|---|---|
| 5251519 | October 1993 | Lang |
| 5199327 | April 1993 | Steveson |
| 364789 | December 1995 | Degyansky |
| 374383 | October 1998 | Malak |
| 4918784 | April 1990 | Cude et al . . . |

As of date all searches relate to other than the precise operation of said newly filed patents. As of Apr. 27, 2004.

### SUMMARY OF THE INVENTION

It is an object of the invention to provide a multiple tool that is solid and useful. It is an object of the invention to provide a multiple tool that saves time from carrying many tools.

It is an object of the invention to provide a multiple tool that eliminates tearing canvas when pulling loose from snaps.

It is an object of the invention to provide a multiple tool to assist in the operation of zippers.

It is an object of the invention to provide a compact multiple tool, to open and close fuel and water caps.

It is an object of the invention to provide a multiple tool to replace and remove a water drain plug.

It is understood, that various changes in the details may be made without departing from the spirit, or sacrificing any of the advantages of the present invention.

### BRIEF DESCRIPTION OF THE DRAWINGS

FIG. A. Is a top elevational view of a multiple function hand tool constructed in accordance with and embodying the features of the present invention.

FIG B. Is a side view of a multiple function hand tool taken along the line 2-2 in FIG A. showing the elevated angled end (9) and the handle portions thereof (20) and FIG A. (10).

### DESCRIPTION OF THE PREFERRED EMBODIMENT

Referring to figure A-B of the drawings, there is illustrated a multiple functional hand Tool generally designated by the numeral (10) in FIG. A. and (20) in FIG. B. with end (9) and opposite end (21), constructed in accordance with the present invention. FIG. A. The tool (10) being a flat metal base and having an end (9) with a slotted cut out (11). Having an extended protrusion (12) from the embodiment (10) and a square cut out (17). The opposite end portion (21) having a cut out portion (16) and a radius (15) FIG. B. referring to the side view of the plane of the handle (20) opposite the radius (15) of FIG. A., the extended portions (13) and (14). The bend (18) shown also in FIG. A. along the line 2-2.

FIG. A. shows the end (9) of embodiment (10) with cut out (11). The cut out portion of (11) is to accommodate the tool for insertion between the snap fastener of the snap, thus acting as a pry tool between the two for the purpose of un-snapping the snap from the fastener, as the tool will fit between the two.

FIG. A. The end (9) of the embodiment (10) with the extended portion (12) that will accommodate the slot (not shown) in a water or gas cap, thus allowing the opening or closing of said parts by said invention. Looking now to the cut out (17) of the embodiment (10), the cut out will accommodate the drain plug in boats, (not shown) to allow removal or installation of said part. Moving now to the end (21) of the embodiment (10) of FIG. A., whereas there are two extended protrusions (13) and (14) which perform the same function as (12) with the exception of use on different type fuel and water caps, (not shown).

FIG. A. Turning now to the cut out (16) of the embodiment (10) of end (21) with the radius (15), the slotted portion (16) is and radius (15) are to accommodate the eye of a zipper pull tab, the relief afforded by the radius (15) will accommodate different size eyelets of a zipper pull. The embodiment (10) acts as a handle in the use of this particular function of said invention. Gus Zeidler

1. A multifunctional hand tool comprising: a handle portion.

2. The tool of claim 1, wherein said end acting as a pry to un-fasten snaps.

3. The tool of claim 1, further comprising of an elongated extended portion thereof at one end for opening and closing, water and fuel caps.

4. The tool of claim 1, wherein said cutout in the handle portion thereof removes and installs drain plugs.

5. The tool of claim 1, wherein said end with two closely related extended protrusions for removing and installing water and fuel caps.

6. The tool of claim 1, further comprising of a cutout portion and radius end portion for assisting in the pulling of zippers, by providing a hook for the eye of the zipper and a handle portion for gripping.
